(19) United States
(12) Patent Application Publication
(10) Pub. No.: US 2015/0216250 A1
(43) Pub. Date: Aug. 6, 2015

(54) PROTECTIVE GARMENT

(71) Applicant: KOKEN LTD., Tokyo (JP)

(72) Inventors: Hironobu Takeuchi, Tokyo (JP); Shinnosuke Shibata, Tokyo (JP); Shoko Matsuda, Tokyo (JP)

(73) Assignee: KOKEN LTD., Tokyo (JP)

(21) Appl. No.: 14/422,308

(22) PCT Filed: Aug. 20, 2013
(86) PCT No.: PCT/JP2013/072192

§ 371 Date: Feb. 18, 2015

(30) Foreign Application Priority Data
Aug. 24, 2012 (JP) 2012-185612

(51) Int. Cl. A42B 3/16; A42B 3/28; A62B 9/06; A62B 7/02; A62B 18/04; A41D 13/11; A62B 18/08

(52) U.S. Cl. CPC A42B 3/16; A41D 13/1153; A41D 13/1161; A42B 3/286; A42B 3/288; A62B 18/08; A62B 7/02; A62B 18/04; A62B 9/06

(57) ABSTRACT

A protective garment enabling a wearer of the protective garment to clearly hear external sounds and thereby ensuring the safety of the wearer's work. The protective garment includes: a protective garment main body covering at least the head of a wearer; ear film members formed with a thickness allowing hearing of external sounds; and a maintaining member maintaining the ear film members in contact with the wearer's ears or in proximity to the wearer's ears within a predetermined distance. Since the ear film members are provided and maintained in contact with the wearer's ears or in proximity to the wearer's ears within a predetermined distance, the wearer can clearly hear external sounds.

### TECHNICAL FIELD

The present invention relates to a protective garment used for protecting a wearer's body from various substances and states harmful to human bodies.

### BACKGROUND ART

Conventionally, protective garments have been used for protecting the bodies of wearers who work in environments involving various substances and states harmful to human bodies. A variety of types of protective garments exist corresponding to the types of substances and states that endanger human bodies, for example, dust protective garments, ballistic-fragment protective garments, fall protective garments, electric-work protective garments, radiation protective garments, fire protective garments, and wasp-extermination protective garments.

The main body of such a protective garment covers at least the head of a wearer in order to protect the wearer's body. That is, protective garments are known such that the main body consists of a hood covering at least the head of a wearer (for example, the wearer's head and upper body), or consists of a suit covering the wearer's entire body and integrated with a hood covering the wearer's head (see Japanese Patent Laid-Open No. 2007-275190, for example).

### SUMMARY OF INVENTION

### Technical Problem

For safe work of a wearer of a protective garment, the wearer in the protective garment needs to be able to hear external sounds. Unfortunately, in the invention described in Patent Literature 1, the wearer's entire head is covered by the hood, so that external sounds are heard inside the hood through the hood material. If the hood material is thick, the wearer may have difficulty in clearly hearing external sounds. Also in the invention described in Patent Literature 1, the wearer's respiration is often ensured by sending purified air into the hood or suit from an air supplier or the like. In this case, portions of the hood corresponding to the wearer's ears tend to be away from the wearer's ears due to, for example, the pressure of the air sent by the air supplier into the hood. Consequently, the invention described in Patent Literature 1 poses the problem of the tendency to poorly-heard external sounds and well-heard internal noises for the wearer in the protective garment. This problem is further noticeable when the air supplier is operated inside the protective garment and produces operational sounds and air-sending sounds leading to increased noises inside the protective garment.

The present invention has been made in view of the above problem, and an object thereof is to provide a protective garment enabling a wearer of the protective garment to clearly hear external sounds and thereby ensuring the safety of the wearer's work.

### Solution to Problem

For the accomplishment of the above object, the protective garment according to the present invention includes: a protective garment main body covering at least a head of a wearer; an ear film member formed with a thickness allowing hearing of external sounds; and a maintaining member maintaining the ear film member in contact with a wearer's ear or in proximity to the wearer's ear within a predetermined distance.

Preferably, in the protective garment of the present invention, the maintaining member maintains the ear film members in contact with or in proximity to the wearer's ear by applying force to the ear film member or to portions where ear members are located in the protective garment main body, in a direction toward the wearer's ears.

Preferably, in the protective garment of the present invention, the maintaining member includes a sound insulating member disposed to surround the wearer's ears to reduce sounds reaching the wearer's ears without passing through the ear film members.

Preferably, in the protective garment of the present invention, the maintaining member further includes an ear pressing member made of an elastic material, openings are provided at both ends of the ear pressing member, respectively, the sound insulating members are provided on the inner surface of the ear pressing member to surround the respective openings, the ear film members are attached to the respective openings, and the sound insulating members are pressed against areas around the wearer's ears due to elastic force of the ear pressing member.

Preferably, in the protective garment of the present invention, the ear pressing member is worn to surround the wearer's ears and back of the head.

Preferably, in the protective garment of the present invention, the maintaining member further includes a vertex band section, one end of the vertex band section being connected to one of the ends of the ear pressing member, and another end of the vertex band section being connected to the other end of the ear pressing member.

Preferably, in the protective garment of the present invention, the vertex band section includes an attaching member to detachably attach the vertex band section to the inner surface of a vertex portion of the protective garment main body.

Preferably, in the protective garment of the present invention, the maintaining member further includes a pair of substantially flat plate members, openings are provided in the respective plate members, the sound insulating members are provided on the inner surface of the plate members to surround the respective openings, the ear film members are attached to the openings, and the plate members are pressed by an ear pressing member against areas around the wearer's ears.

Preferably, in the protective garment of the present invention, the ear pressing member is a fastening band to fix a protective mask to the wearer's head.

Preferably, in the protective garment of the present invention, an ear film member is provided in the protective garment main body, and the ear pressing member has a curved portion formed to be curved, the curved portion being engaged in a position corresponding to a root of each auricle of the wearer over the protective garment main body.

Preferably, in the protective garment of the present invention, the ear film member is detachably provided in the protective garment main body.

Preferably, in the protective garment of the present invention, the ear pressing member is detachably provided in the protective garment main body.

Preferably, in the protective garment of the present invention, an air supplier sending air into the protective garment main body, or a breathing apparatus supplying air in a tank to the wearer through a tube, is provided in the protective garment.

Preferably, in the protective garment of the present invention, a mouth opening is formed in a portion of the protective garment main body corresponding to the wearer's mouth, and a mouth film member transmitting the wearer's speech to the outside is provided at the mouth opening.

Preferably, in the protective garment of the present invention, the ear film members are made of the same material as the mouth film member.

Preferably, the protective garment of the present invention further includes a mouth pressing member provided outside the mouth film member, the mouth pressing member being pressed against an area around the wearer's mouth so that the mouth film member is disposed in a portion corresponding to the wearer's mouth.

### Advantageous Effects of Invention

According to the protective garment of the present invention, the protective garment is provided with the ear film members, each formed of a thin film to allow hearing of external sounds. This facilitates transmission of sounds from outside into the protective garment through the ear film members. The ear film members are disposed in portions of the protective garment main body corresponding to the wearer's ears so that the ear film members are in contact with or in proximity to the wearer's ears. This provides a state in which the wearer can easily hear sounds outside the protective garment. Thus, the wearer in the protective garment can clearly hear external sounds, so that the safety of the wearer's work can be ensured.

In the present invention, the maintaining member may maintain the ear film members in contact with or in proximity to the wearer's ears using force toward the wearer's ears. This keeps the wearer capable of easily hearing external sounds when the ear film members tend to be away from the wearer's ears due to, for example, air being sent by an air supplier into the protective garment main body. Thus, the wearer in the protective garment can even more clearly hear external sounds.

In the present invention, the maintaining member may be provided with the sound insulating members to be in close contact with areas around the wearer's ears. This can prevent the wearer from hearing noises transmitted into the protective garment main body. As a result, hearing of sounds outside the protective garment through the ear film members is facilitated.

In the present invention, the maintaining member may be provided with the ear pressing member. This can simply and reliably provide a state in which the wearer can easily hear external sounds.

In the present invention, the ear pressing member may be configured to surround the wearer's ears and back of the head. This facilitates putting on the maintaining member.

In the present invention, the vertex band section may be provided. This can make the maintaining member hard to be detached from the wearer's head.

In the present invention, the vertex band section may be attached to the protective garment main body with the attaching member. This can prevent misalignment of the maintaining member.

In the present invention, the plate members may be provided with the respective sound insulating members and the respective ear film members, and fixed with the ear pressing member. This can simply and reliably provide a state in which the wearer can easily hear external sounds.

In the present invention, the fastening band of the protective mask may be used as the ear pressing member. This allows the wearer to clearly hear external sounds even when wearing the protective mask.

In the present invention, the ear film members may be provided in the protective garment main body and pressed by the ear pressing member against the wearer's ears. This can facilitate keeping the ear film members in contact with or in proximity to the wearer's ears.

In the present invention, the ear film members may be detachable from the protective garment main body. Thus, during the use of the protective garment, the ear film members can be attached to the protective garment main body to stabilize the use. When the protective garment is not used, enhanced maintainability of the ear film members and easy replacement in the case of breakage of the ear film members can be achieved.

In the present invention, the ear pressing member may be detachable from the protective garment main body. Thus, during the use of the protective garment, the ear pressing member can be attached to the protective garment main body to stabilize the use. When the protective garment is not used, enhanced maintainability of the ear pressing member and easy replacement in the case of breakage of the ear pressing member can be achieved.

In the present invention, the air supplier or the breathing apparatus may be provided. This allows the wearer in the protective garment to clearly hear external sounds while ensuring the wearer's respiration inside the protective garment main body.

In the present invention, the mouth film member may be provided. This allows the wearer's speech to be clearly transmitted to the outside of the protective garment, thereby increasing the safety of the wearer.

In the present invention, the ear film members and the mouth film member may be made of the same material. This allows the ear film members and the mouth film member to be manufactured in the same process, thereby reducing the manufacture cost.

In the present invention, the mouse pressing member may be provided to press the mouse film member. Thus, during the use of the protective garment, the mouth film member can be stably disposed in a portion corresponding to the wearer's mouth to allow the wearer's speech to be even more clearly transmitted to the outside.

### BRIEF DESCRIPTION OF DRAWINGS

FIG. 1 is a diagram showing a wearer wearing a protective garment according to a first embodiment of the present invention.

FIG. 2 is a diagram showing the wearer wearing the protective garment according to the first embodiment.

FIG. 3 is a partial sectional view showing the wearer wearing the protective garment according to the first embodiment.

FIG. 4 is a partial sectional view showing the wearer wearing the protective garment according to the first embodiment.

FIG. 5 is a diagram showing an ear film member unit used for the protective garment according to the first embodiment.

FIG. 6 is a diagram showing the wearer putting on the ear film member unit used for the protective garment according to the first embodiment.

FIG. 7A is a diagram showing a first exemplary ear film member adapter used for the protective garment according to the first embodiment.

FIG. 7B is a diagram showing a second exemplary ear film member adapter used for the protective garment according to the first embodiment.

FIG. 8 is a diagram showing a hood of the protective garment according to the first embodiment, and the ear film member unit before being attached to the hood.

FIG. 9 is a diagram showing an ear film member unit used for a protective garment according to a second embodiment of the present invention.

FIG. 10 is a diagram showing the wearer putting on a protective mask and the ear film member unit used for the protective garment according to the second embodiment.

FIG. 11 is a diagram showing a protective garment according to a third embodiment of the present invention before an ear pressing member is attached.

FIG. 12 is a diagram showing the protective garment according to the third embodiment with the ear pressing member attached.

FIG. 13 is a diagram showing the wearer wearing a protective garment according to a fourth embodiment of the present invention.

FIG. 14 is a diagram showing the wearer wearing the protective garment according to the fourth embodiment.

### DESCRIPTION OF EMBODIMENTS

### First Embodiment of Invention

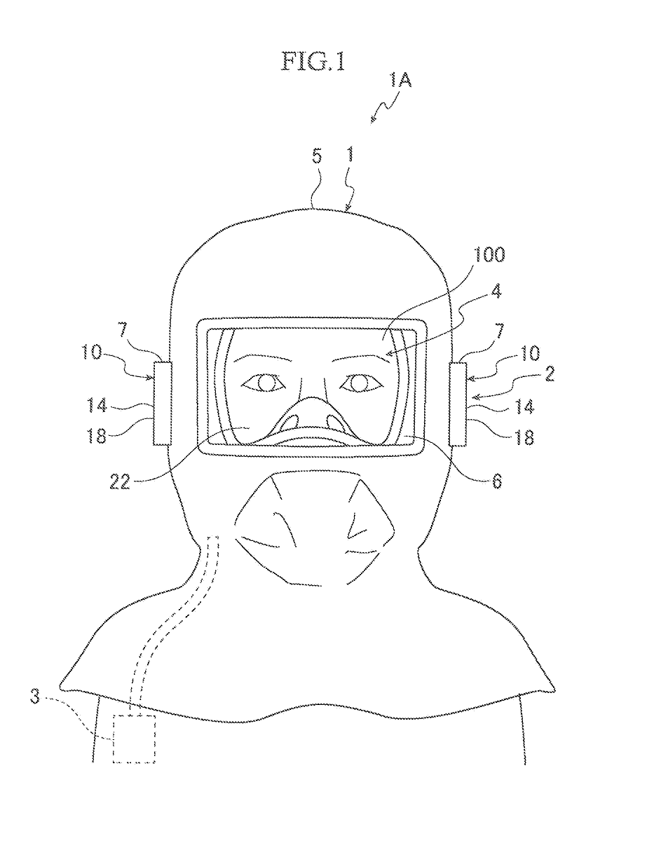

FIGS. 1 to 8 show a first embodiment of the present invention.

First, the configuration will be described. A protective garment 1A in the first embodiment shown in FIG. 1 is what is called a hood-type respiratory protector.

Here, the protective garment 1A in the first embodiment shown in the figures such as FIG. 1 represents what is called a chemical protective garment for protecting the head and part of the upper body of a wearer 100 from a toxic chemical, for example from splashes of a toxic chemical solution or from toxic fumes.

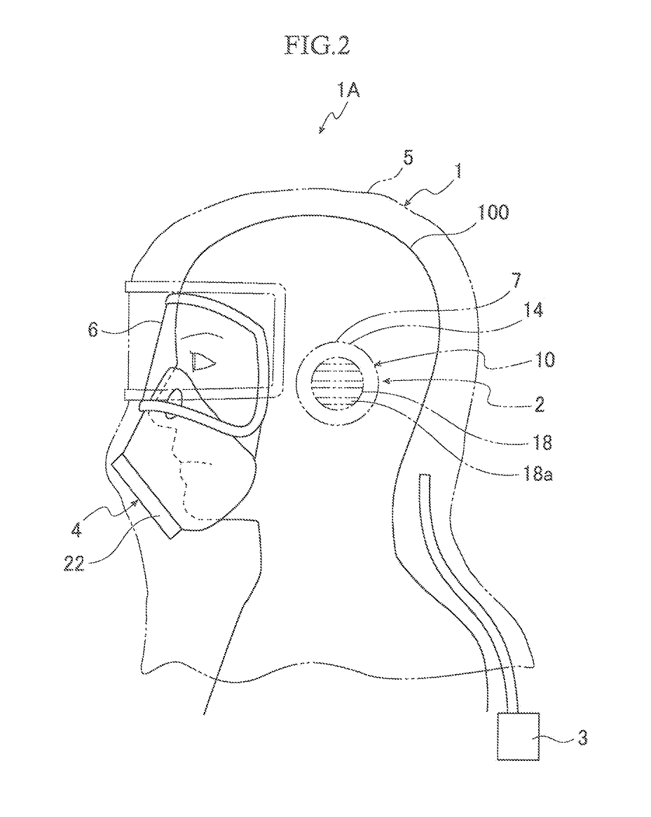

The protective garment 1A in the first embodiment shown in FIGS. 1 and 2 includes a hood 1 as a “protective garment main body”, and an ear film member unit 2 as “ear film members”, a “maintaining member”, “sound insulating members”, and an “ear pressing member”. In the first embodiment, the protective garment 1A further includes an air supplier 3. Also in the first embodiment, the wearer 100 further wears a protective mask 4.

The hood 1 in the first embodiment includes a body-covering section 5 and a window section 6.

The body-covering section 5 of the hood 1 shown in FIGS. 1 and 2 is made of, for example, a soft vinyl chloride, high-density polyethylene nonwoven fabric, or fluorine resin sheet. However, the body-covering section 5 may be made of any material that is flexible, highly dust-proof, and highly liquid-tight.

The body-covering section 5 is configured to cover at least the head of the wearer 100. That is, as shown in FIG. 2, the body-covering section 5 covers the entire head, the part around the neck, and the upper body around the shoulders and chest of the wearer 100.

The window section 6 is provided in a portion of the hood 1 corresponding to the eyes of the wearer 100. The window section 6 is made of a transparent or semitransparent member such as a resin (e.g., a soft vinyl chloride, polycarbonate, or acrylic) or glass, and ensures the vision of the wearer 100.

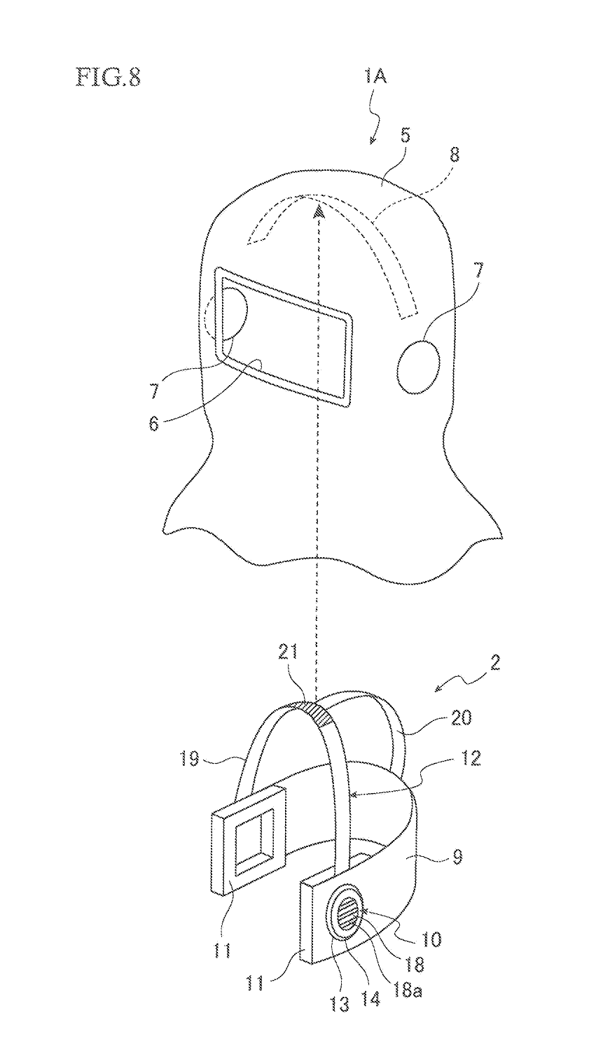

As shown in FIG. 8, substantially circular ear openings 7 are formed in respective portions of the body-covering section 5 corresponding to the ears 101 of the wearer 100. Ear film member adapters 10 (to be described later) of the ear film member unit 2 are inserted into the ear openings 7.

As shown in FIG. 8, a hook-and-loop fastener 8 is provided in a portion of the inner surface of the body-covering section 5 corresponding to the top of the head of the wearer 100. The hook-and-loop fastener 8, which is a male or female element of a hook-and-loop fastener, is provided at a position to be contacted by a vertex band section 12 (to be described later) of the ear film member unit 2, as a counterpart of a hook-and-loop fastener 21 on the vertex band section 12.

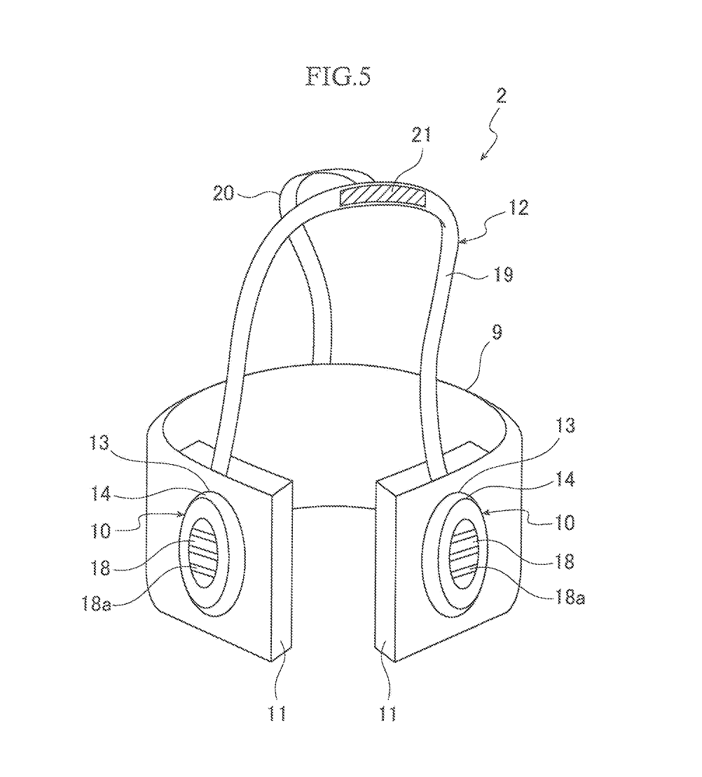

As shown in FIG. 5, the ear film member unit 2 includes an ear pressing member 9, ear film member adapters 10, sound insulating members 11, and a vertex band section 12.

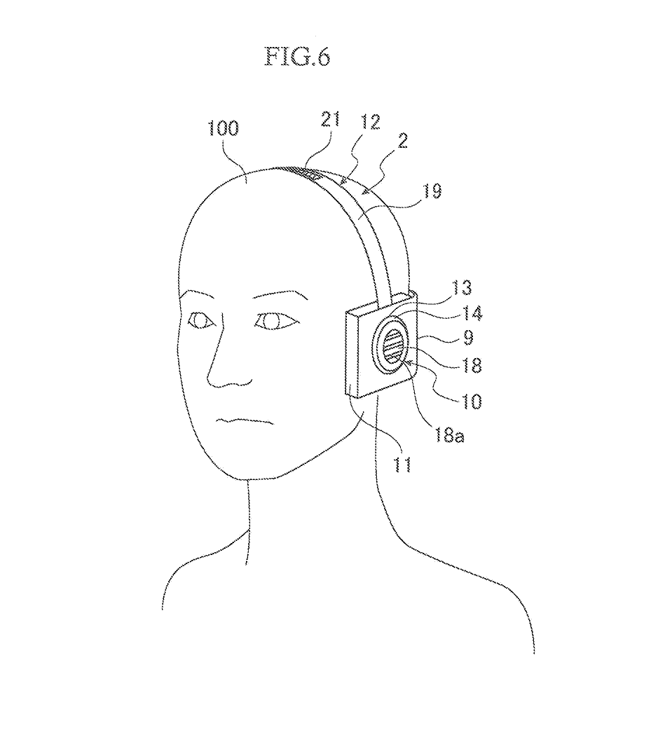

The ear pressing member 9 shown in FIG. 5 is made of a material with sufficient elasticity and rigidity, such as an acrylic resin. As shown in FIG. 5, the ear pressing member 9 is formed of a substantially U-shaped plate member curved at the center. The ear pressing member 9 is elastically deformable with its both ends moved toward and away from each other. When the ear pressing member 9 is disposed on the head of the wearer 100, the head of the wearer 100 is caught between both ends due to the elasticity, as shown in FIG. 6. Therefore, when the wearer 100 puts the ear film member unit 2 on his head, the ear film member adapters 10 and ear film members 18 (to be described later) put in the ear film member adapters 10 are maintained in contact with or in proximity to the ears of the wearer 100. The ear film members 18 in proximity to the wearer 100 may be within a distance from the respective ears that allows the wearer 100 to sufficiently hear external sounds.

As shown in FIG. 5, insertion openings 13 are formed near both ends of the ear pressing member 9, respectively. The ear film member adapters 10 are inserted into the insertion openings 13.

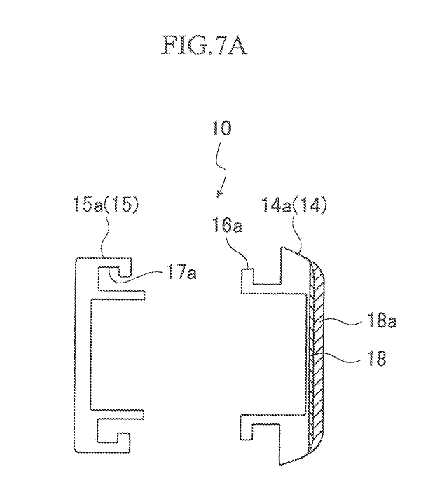

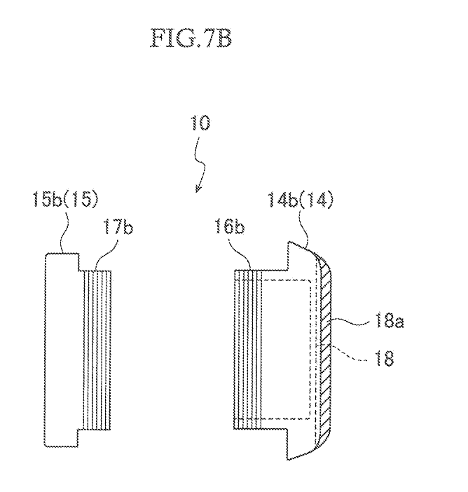

For example, as shown in FIG. 7A, each ear film member adapter 10 includes a substantially cylindrical adapter fitting element 14a, and a substantially cylindrical adapter fitted element 15a to be fitted into the adapter fitting element 14a. The adapter fitting element 14a and the adapter fitted element 15a are made of a highly rigid material, for example polypropylene. In this case, as shown in FIG. 7A, fitting convex portions 16a on the adapter fitting element 14a are fitted into fitted concave portions 17a on the adapter fitted element 15a, so that the two elements of the ear film member adapter 10 are coupled with each other.

In another example in FIG. 7B, each ear film member adapter 10 includes a substantially cylindrical adapter fitting element 14b, and a substantially cylindrical adapter fitted element 15b to be fitted into the adapter fitting element 14b. Thread grooves 16b and 17b cut on the respective adapter fitting element 14b and adapter fitted element 15b are engaged, so that the two elements of the ear film member adapter 10 are coupled with each other. The adapter fitting elements 14a and 14b and the adapter fitted elements 15a and 15b may have other configurations as long as one is fitted into the other. For the sake of simplicity, the adapter fitting elements 14a and 14b and the adapter fitted elements 15a and 15b will be denoted in the following description as an adapter fitting element 14 and an adapter fitted element 15, respectively.

The size of the rim of the adapter fitting element 14 of each ear film member adapter 10 is substantially the same as the ear openings 7 shown in FIG. 8.

As shown in FIGS. 7A and 7B, a circular ear film member 18 is attached on the outer surface of the adapter fitting element 14 of each ear film member adapter 10.

The ear film member 18 is formed as a thin film, for example, a soft vinyl chloride or fluorine resin film similar to the material of the hood 1, a resin film (typified by polyethylene, polyethylene terephthalate (PET), polyurethane, polyimide, or polyamide, or the like), or a rubber film.

In the first embodiment, the ear film member 18 is thinner than the hood 1. Specifically, the ear film member 18 is preferably around 0.01 to 0.1 mm thick (for example, around 0.03 to 0.1 mm thick for a rubber film, and around 0.01 to 0.05 mm (more preferably around 0.01 to 0.03 mm) thick for a resin film). However, the ear film member 18 may be in any shape and of any size, material, and thickness, as long as the wearer 100 can easily hear sounds outside the hood 1.

The ear film member 18 is disposed in proximity to the ear of the wearer 100 while the ear film member unit 2 is put on the head of the wearer 100. In the first embodiment, with respect to the distance between the ear film member 18 and the ear of the wearer 100, the edge of the ear is preferably within 5 mm from the ear film member 18. However, the ear may be in contact with the ear film member 18, or the edge of the ear may be more than 5 mm away from the ear film member 18 as long as the wearer 100 can hear external sounds well. (This also applies to embodiments to be described below.)

As shown in FIGS. 7A and 7B, a protecting member 18a is provided over the ear film member 18 of each ear film member adapter 10. The protecting member 18a has tilted plate elements arranged in parallel and spaced apart from adjacent ones, thereby aiming good sound transmission as well as protection of the ear film member 18 from damage. The protecting member 18a may have any structure as long as it can achieve good sound transmission as well as protection of the ear film member 18 from damage, for example a lattice structure or a porous structure. Alternatively, the ear film member adapter 10 may not be provided with the protecting member 18a, so that the ear film member 18 may be exposed outside.

The ear film member adapters 10 are detachable from the respective insertion openings 13 of the ear pressing member 9. This can facilitate maintenance and replacement of the ear film member adapters 10, particularly the ear film members 18. The ability to break down each ear film member adapter 10 into the adapter fitting element 14 and the adapter fitted element 15 can further facilitate maintenance, replacement, etc. thereof to enhance convenience.

As shown in FIG. 5, when the ear film member adapters 10 are inserted into the respective insertion openings 13 and attached to the ear pressing member 9, part of the ear film member adapters 10 protrudes outward from the insertion opening 13.

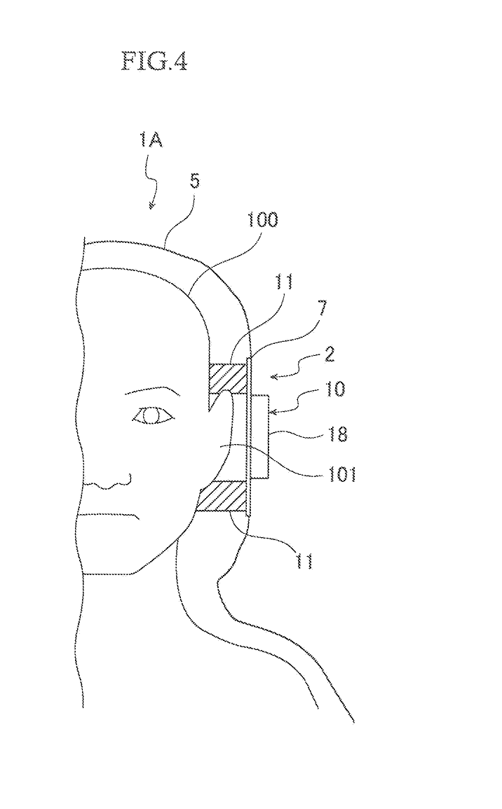

As shown in FIGS. 5 and 8, the sound insulating members 11, having a frame shape for example, are provided around the respective insertion openings 13. The sound insulating members 11 are made of a material with a good elasticity and sound insulation property, for example an expanded synthetic resin (typified by expanded polyurethane) or foam rubber. However, the sound insulating members 11 may be made of any material with a sound insulation property. When the ear pressing member 9 is put on the head of the wearer 100 as shown in FIG. 6, the sound insulating members 11 are pressed against areas around the ears 101 of the wearer 100 as shown in FIG. 4. In the first embodiment, the sound insulating members 11 are provided in the entire areas around the insertion openings 13, as shown in FIG. 8. However, the sound insulating member 11 may be provided only in part of the areas around the insertion openings 13 as long as the ears 101 of the wearer 100 are insulated from noises transmitted into the hood 1 when the sound insulating members 11 are disposed around the ears of the wearer 100 as shown in FIGS. 4 and 6. (The noises here refer to noises generated inside the hood 1 and/or noises generated outside the hood 1 and transmitted into the hood 1, for example operational sounds and air-sending sounds of the air supplier 3.)

As shown in FIG. 5, the vertex band section 12 is provided around one of the longitudinal sides (the upper side in FIG. 5) of the ear pressing member 9. The vertex band section 12 includes a side band 19 connected between both ends of the ear pressing member 9, and a back band 20 connected between the center of the ear pressing member 9 and about the center of the side band 19. A hook-and-loop fastener 21 is provided at about the center of the side band 19. The hook-and-loop fastener 21 is attachable to the inner surface of the body-covering section 5.

The vertex band section 12 is for preventing the ear pressing member 9 of the ear film member unit 2 from slipping down from the head of the wearer 100 when the ear pressing member 9 is put on the head of the wearer 100. Besides the above structure consisting of the side band 19 and the back band 20, any structure may be employed as long as the ear pressing member 9 can be prevented from slipping down from the head of the wearer 100.

As shown in FIGS. 1 and 2, the air supplier 3 is provided inside the hood 1. The air supplier 3, having an air purification function and an air intake and sending function, supplies purified air to the wearer 100 by taking in air outside the hood 1, eliminating smoke and dust through a filter or the like, and sending the purified air into the hood 1.

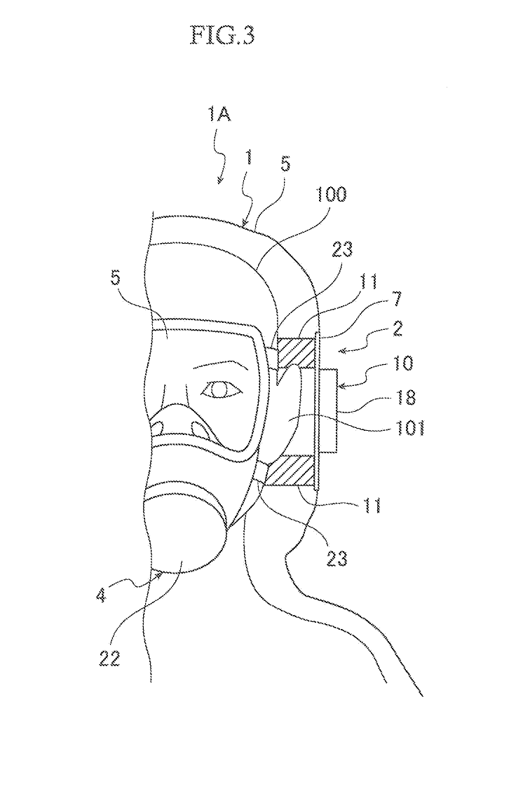

The protective mask 4 is provided for preventing the face and respiratory system of the wearer 100 from being affected by smoke and toxins. As shown in FIG. 3, the protective mask 4 in the first embodiment has a face piece of what is called a full-face type, and the protective mask 4 is of a filtration type with no power for sending air passed through a filter (not shown).

As shown in FIG. 3, the protective mask 4 in the first embodiment includes a mask main body 22 covering the face of the wearer 100, and a pair of rubber bands 23, 23 fixing the mask main body 22 to the face of the wearer 100. The filter (not shown) is provided in a portion of the mask main body 22 corresponding to the mouth of the wearer 100. The filter (not shown) provides a function of eliminating smoke, dust and toxins from incoming air. The wearer 100 can wear the protective mask 4 to avoid inhaling smoke, dust and toxins that could not be filtered out by the air supplier 3.

Now, operation in the first embodiment will be described.

First, the wearer 100 who is going to wear the protective garment 1A assembles each ear film member adapter 10 by fitting the adapter fitting element 14 into the adapter fitted element 15. The wearer 100 further inserts the ear film member adapter 10 into each insertion opening 13 of the ear pressing member 9 to attach the ear film member adapter 10 to the ear pressing member 9. The ear film member unit 2 as shown in FIG. 5 is thus completed. Alternatively, when the adapter fitting element 14 is fitted into the adapter fitted element 15, the edge of the insertion opening 13 may be tucked between the adapter fitting element 14 and the adapter fitted element 15 to thereby attach the ear film member adapter 10 to the ear pressing member 9.

The wearer 100 then puts the protective mask 4 and further the ear film member unit 2 on his head, as shown in FIG. 3. At this point, as shown in FIG. 6, both ends of the ear pressing member 9 are located at the ears, and the portion from both sides to the center of the ear pressing member 9 is located at the back of the head. The side band 19 is located extending from the temporal parts to the top of the head. Further, the back band 20 is located extending from the back to top of the head. The sound insulating members 11 are located surrounding the ears 101 of the wearer 100. Thus, the ear pressing member 9 can be fixedly put on the head of the wearer 100 and accordingly be prevented from slipping down from the head of the wearer 100. In the first embodiment, the sound insulating members 11 are pressed against the areas around the ears 101 of the wearer 100 due to the elastic force of the ear pressing member 9, as shown in FIG. 4. As a result, the ear film members 18 of the ear film member adapters 10 are located in proximity to the ears 101 of the wearer 100, as shown in FIG. 4.

The wearer 100 then put on the hood 1 over his head. The wearer 100 attaches the hook-and-loop fastener 21 on the vertex band section 12 to the hook-and-loop fastener 8 inside the hood 1 to fix the ear film member unit 2 to the hood 1, as shown in FIG. 8. The wearer 100 further inserts the portions of the ear film member adapters 10 protruding from the insertion openings 13 into the ear openings 7 of the hood 1 to partially expose the ear film member adapters 10 outside the hood 1, as shown in FIG. 4. Thus, wearing of the protective garment 1A is completed. The wearer 100 turns the switch of the air supplier 3 on and works with purified air sent into the hood 1.

As described above, in the first embodiment, the protective garment 1A is provided with the ear film members 18. The ear film members 18 are each formed of a thin film and therefore facilitate transmission of sounds outside the protective garment 1A into the hood 1 through the ear film members 18.

The hood 1 tends to be inflated and away from the ears 101 of the wearer 100 especially when air is being sent by the air supplier 3. However, in the protective garment 1A of the first embodiment, the ear film member adapters 10 are pressed against the head by the ear pressing member 9. Therefore, even if the hood 1 is inflated, the ear film members 18 are maintained in contact with or in proximity to the ears 101 of the wearer 100 in the portions of the hood 1 corresponding to the ears 101 of the wearer 100. This can provide a state in which the wearer 100 can easily hear sounds outside the protective garment. The wearer 100 can thus hear external sounds through the ear film members 18 while wearing the protective garment 1A.

When the air supplier 3 is operating, sounds such as motor-rotation sounds and air-sending sounds reverberate in the hood 1 to become big noises in the hood 1. In this respect, the protective garment 1A in the first embodiment includes the sound insulating members 11 around the ear film member adapters 10 in which the ear film members 18 are disposed. The sound insulating members 11 are disposed to be pressed by the ear pressing member 9 against the areas around the ears 101 of the wearer 100. Therefore, in the protective garment 1A, the sound insulating members 11 are in close contact with the areas around the ears 101 of the wearer 100. As a result, inside the hood 1, the ears of the wearer 100 are insulated by the sound insulating members 11 from noises, so that noises transmitted into the hood 1 from sources such as the air supplier 3 are hard to reach the ears 101 of the wearer 100. This allows the wearer 100 to even more easily hear sounds outside the protective garment 1A through the ear film members 18.

As described above, the ear pressing member 9 pressing the sound insulating members 11 against the areas around the ears 101 of the wearer 100 is disposed on the head of the wearer 100. This ensures that the sound insulating members 11 are pressed against the ears of the wearer 100, so that the wearer 100 can easily hear external sounds.

As described above, the ear pressing member 9 is formed in a substantially U shape with an elastic material and disposed on part of the head of the wearer 100. In addition, the sound insulating members 11 are provided at both ends of the ear pressing member 9, and the ear film members 18 are further provided inside the sound insulating members 11. As a result, by disposing the ear pressing member 9 on part of the head of the wearer 100, the ear film members 18 can be brought in proximity to or in contact with the ears 101 of the wearer 100, and therefore the sound insulating members 11 can be located around the ears 101 of the wearer 100.

As has been described above, the first embodiment enables the wearer 100 in the protective garment 1A to clearly hear external sounds, thereby ensuring the safety of his work.

In the first embodiment, the ear film members 18 are provided in the ear film member adapters 10, and the ear film member adapters 10 are attached to the ear pressing member 9 and brought in proximity to the ears of the wearer 100. However, the present invention is not limited to this configuration. For example, the ear film members 18 may be directly attached to the ear pressing member 9. That is, advantages of the present invention may be achieved with any configuration as long as the ear film members 18 can be brought in proximity to the ears of the wearer 100. Instead of being brought in proximity to the ears of the wearer 100, the ear film members 18 may be brought in contact with the ears of the wearer 100 by, for example, disposing the ear film members 18 behind the ear film member adapters 10 (i.e., on the side nearer the ears 101 of the wearer 100 wearing the protective garment 1A).

In the first embodiment, the vertex band section 12 is provided in the ear film member unit 2 to prevent the ear pressing member 9 from slipping down from the head of the wearer 100. However, the slipping down of the ear pressing member 9 from the head of the wearer 100 may be prevented without the vertex band section 12 by, for example, disposing the ear pressing member 9 at the ears via the top of the head of the wearer 100. Also, the vertex band section 12 and the inside of the hood 1 may not be provided with the hook-and-loop fasteners 21 and 8. Further, the ear pressing member 9 in the first embodiment may not be provided with the vertex band section 12.

In the first embodiment, the protective garment 1A is provided with the ear pressing member 9 and the sound insulating members 11. However, one or both of the ear pressing member 9 and the sound insulating members 11 may not be provided. Even in that case, a mechanism is necessary for bringing the ear film members 18 in proximity to or in contact with the ears 101 of the wearer 100 during the use of the protective garment 1A.

In first embodiment, the wearer 100 puts the ear pressing member 9 on his head and then wears the hood 1. However, the protective garment may be configured such that the wearer 100 puts on the ear pressing member 9 over the hood 1.

In the first embodiment, the wearer 100 wears the protective mask 4. However, the wearer 100 may not wear the protective mask 4.

In the first embodiment, the protective garment 1A of the present invention is what is called a chemical protective garment. However, the protective garment 1A may be of other types used for various purposes, for example: a dust protective garment for protecting the body of the wearer 100 from dust (such as asbestos dust) or smoke; a ballistic-fragment protective garment for protecting the body of the wearer 100 from bullets, debris due to an explosion, fallen objects, etc.; a fall protective garment for protecting the body of the wearer 100 from an impact of landing in a falling accident; an electric-work protective garment for protecting the body of the wearer 100 from an electric shock accident in electric work; a radiation protective garment for protecting the body of the wearer 100 from radiation; a fire protective garment for protecting the body of the wearer 100 from fire or high heat; and a wasp-extermination protective garment for protecting the body of the wearer 100 from wasp stings. (This also applies to embodiments to be described below.)

The body-covering section 5 of the hood 1 in the first embodiment is made of a soft vinyl chloride, high-density polyethylene nonwoven fabric, or fluorine resin sheet. However, if the protective garment 1A is not used as a chemical protective garment but used for other purposes, the body-covering section 5 may be made of a material other than the above materials, depending on the purpose of use. (This also applies to embodiments to be described below.)

The body-covering section 5 of the hood 1 in the first embodiment may cover at least the head of the wearer 100. That is, the body-covering section 5 may further cover body parts other than the head, or may have one or more openings formed in one or more portions thereof corresponding to parts of the head, such as a portion corresponding to the face of the wearer 100. (This also applies to embodiments to be described below.)

The “protective garment main body” of the protective garment 1A in the first embodiment consists of only the hood 1. However, in addition to the hood 1, the protective garment main body may include a suit (not shown) protecting at least part of the torso of the wearer 100 (for example, only the torso, the torso and both arms, or the torso and both arms and legs). (This also applies to embodiments to be described below.)

The ear pressing member 9 in the first embodiment is substantially U-shaped. However, the ear pressing member 9 may be in any shape other than the substantially U shape shown in FIG. 5, as long as the ear film members 18 can be maintained in contact with or in proximity to the ears of the wearer 100 when the wearer 100 puts the ear film member unit 2 on his head. For example, the ear pressing member 9 may be in a shape like a headband surrounding the lateral sides of the head of the wearer 100, or a cup shape covering the upper portion of the head. (This also applies to embodiments to be described below.)

The hook-and-loop fasteners 8 and 21 are used for attaching the vertex band section 12 to the body-covering section 5 in the first embodiment. However, attaching members other than the hook-and-loop fasteners 8 and 21 may be used. For example, as the attaching members, one of the vertex band section 12 and the body-covering section 5 may have a fitting element of a button, and the other may have a fitted element of the button. As another example, one of the vertex band section 12 and the body-covering section 5 may have a male screw element, and the other may have a female screw element. As another example, each of the vertex band section 12 and the body-covering section 5 may have one of a pair of elements of a slide fastener to be engaged with each other. As another example, one of the vertex band section 12 and the body-covering section 5 may have a slit on it, and a belt on the other may be inserted into the slit. As another example, a hook on one of the vertex band section 12 and the body-covering section 5 may be hooked on to a loop on the other. As another example, the vertex band section 12 may be held down by contraction of a rubber band or the like provided in the body-covering section 5. As another example, a position corresponding to the vertex band section 12 may be held down by a rubber string or the like (not shown) over the body-covering section 5. (This also applies to embodiments to be described below.)

In the first embodiment, the air supplier 3 is implemented as an electric ventilator provided in the protective garment 1A. However, the air supplier 3 may be implemented otherwise. For example, the air supplier 3 may be implemented in such a manner that air is sent from a cylinder carried on the back of the wearer 100 into the hood 1 or the face piece of the protective mask 4 through a hose. As another example, air compressed by an electric ventilator (such as a compressor) provided separately from the protective garment 1A may be sent into the hood 1 or the face piece of the protective mask 4 through a hose. As another example, an electric ventilator may be provided in the protective mask 4 and send air into the face piece of the protective mask 4. (This also applies to embodiments to be described below.)

The protective mask 4 employed in the first embodiment has the face piece (i.e., the portion covering the face) of the full-face type (i.e., covering the entire face), and the protective mask 4 is of the filtration type (i.e., air supplied to the wearer 100 is filtered) and has no power for passing air through the filter (not shown). However, other types of protective mask 4 may be employed as long as the respiration of the wearer 100 can be ensured. For example, the face piece of the protective mask 4 may be of a half-face (i.e., covering only the mouth and nose) or face-shield (i.e., covering the eyes, nose, and mouth) type. The protective mask 4 may have an air-supplying power. Further, the protective mask 4 may not be of the filtration type but may be what is called an air-supplied type, including an air-supplied respirator, an air line respirator, self-contained breathing apparatus, or the like. (This also applies to embodiments to be described below.)

The first embodiment takes as an example the case in which the full-face protective mask 4 is put on the head of the wearer 100, and further the hood 1 with no face opening covers the entire head. However, the present invention is applicable to other types of protective garments and protective masks. (This also applies to embodiments to be described below.) Specifically, the present invention is applicable to a case in which the wearer 100 wears a protective garment without wearing a protective mask, for example. The present invention is also applicable to a case in which the wearer 100 wears a protective mask of a type other than the full-face type (e.g., the half-face type) and wears a protective garment, for example. The present invention is also applicable to a case in which the wearer 100 wears a protective mask and wears a protective garment having a face opening, and further exposes the face and/or the protective mask of the wearer 100 from the face opening of the protective garment, for example.

### Second Embodiment of Invention

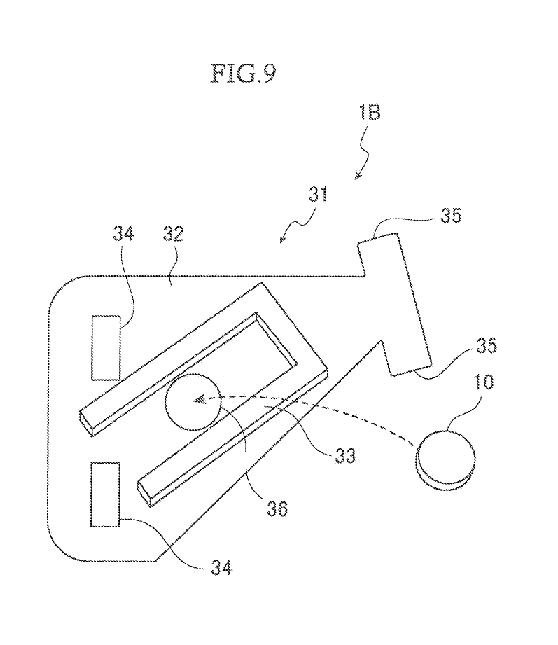

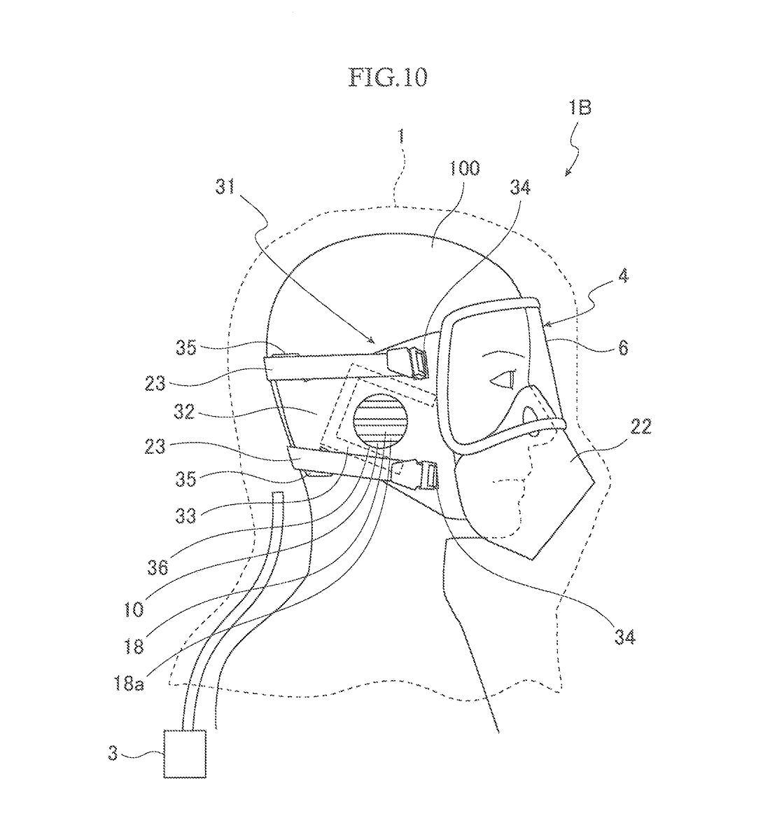

FIGS. 9 and 10 show a second embodiment of the present invention.

A protective garment 1B in the second embodiment shown in FIG. 10 includes, instead of the ear film member unit 2 of the protective garment 1A in the first embodiment, ear film member units 31 as the “maintaining member” shown in FIG. 9. Each ear film member unit 31 includes a plate member 32 corresponding to the “ear pressing member”, a sound insulating member 33, and an ear film member adapter 10. In the second embodiment, the rubber bands 23 of the protective mask 4, which is used in the first embodiment of the present invention as well, are also used as the “ear pressing member”.

The plate member 32 in the second embodiment shown in FIG. 9 is made of a rigid material, for example acrylic. The plate member 32 in the second embodiment is formed in a substantially triangular shape such that the width (the vertical length in FIG. 9) decreases from the front end (the left side in FIG. 9) toward the back end (the right side in FIG. 9). However, the plate member 32 may be in any shape as long as it can be easily disposed at each temporal part of the wearer 100. As will be described, the front end of the plate member 32 is disposed on the front side of the temporal part of the wearer 100, and the back end is disposed on the back side of the temporal part of the wearer 100.

A pair of insertion holes 34, 34 are provided at the front end of the plate member 32. The pair of rubber bands 23, 23 of the protective mask 4 shown in FIG. 10 are inserted into the insertion holes 34, 34. A pair of pressed convex portions 35, 35 laterally protrude from the back end of the plate member 32. The pressed convex portions 35 have a function of causing the rubber bands 23, 23 of the protective mask 4 to press the plate member 32 against the head of the wearer 100 when the protective mask 4 is worn by the wearer 100.

A substantially circular insertion opening 36 is provided at about the center of the plate member 32. The insertion opening 36 has a shape substantially identical with the shape of the rim of the ear film member adapter 10.

A sound insulating member 33 is provided in a substantially U shape to face three directions around the insertion opening 36. The sound insulating member 33 is made of the same material as and has the same function as the sound insulating members 11 in the first embodiment.

The ear film member adapter 10 is inserted into the insertion opening 36 and attached thereto. The ear film member adapter 10 has the same structure as the ear film member adapter 10 in the first embodiment. Other components are the same as in the first embodiment.

Now, operation in the second embodiment will be described.

For the protective garment 1B in the second embodiment, the wearer 100 attaches the ear film member adapter 10 to the insertion opening 36 of each ear film member unit 31, as shown in FIG. 10. From this state, the wearer 100 attaches the pair of ear film member units 31, 31 to the right and left sides of the protective mask 4, respectively, with the sound insulating members 33 facing inside. Specifically, the rubber bands 23 of the protective mask 4 are inserted into the respective insertion holes 34 so that the front end of each plate member 32 contacts the side portion of the mask main body 22 of the protective mask 4.

From this state, the wearer 100 puts the protective mask 4 on his head. Then the ear film member units 31 are disposed on the temporal parts of the wearer 100, as shown in FIG. 10. At this point, the pressed convex portions 35 of each plate member 32 are pressed by the respective rubber bands 23 of the protective mask 4 against the head of the wearer 100. The plate members 32 are therefore pressed against the temporal parts of the wearer 100. In this state, the sound insulating members 33 are pressed against the areas around of the ears 101 of the wearer 100, and the ear film members 18 in the ear film member adapters 10 are disposed in proximity to the ears of the wearer 100.

That is, in the second embodiment, the plate members 32 are attached to the protective mask 4 and put on the head of the wearer 100 together with the protective mask 4. This can simply and reliably provide a state in which the ear film members 18 are in contact with or in proximity to the ears 101 of the wearer 100 while the plate members 32 and the rubber bands 23 as the “ear pressing member” are disposed around the ears 101 of the wearer 100. The wearer 100 in the protective garment 1B used together with the protective mask 4 can thus even more clearly hear external sounds.

In the second embodiment, the sound insulating members 33 are formed in a substantially U shape. However, the sound insulating members 33 may be in any shape as long as the plate members 32 can be attached to the temporal parts of the wearer 100 to insulate the portions corresponding to the ears of the wearer 100 from noises transmitted into the hood 1 (see FIG. 1).

Although the rubber bands 23 of the protective mask 4 are used as part of the “ear pressing member” in the second embodiment, this is not limitation. Any mechanism for pressing the plate members 32 against the head of the wearer 100 may be used instead of the rubber bands 23.

### Third Embodiment of Invention

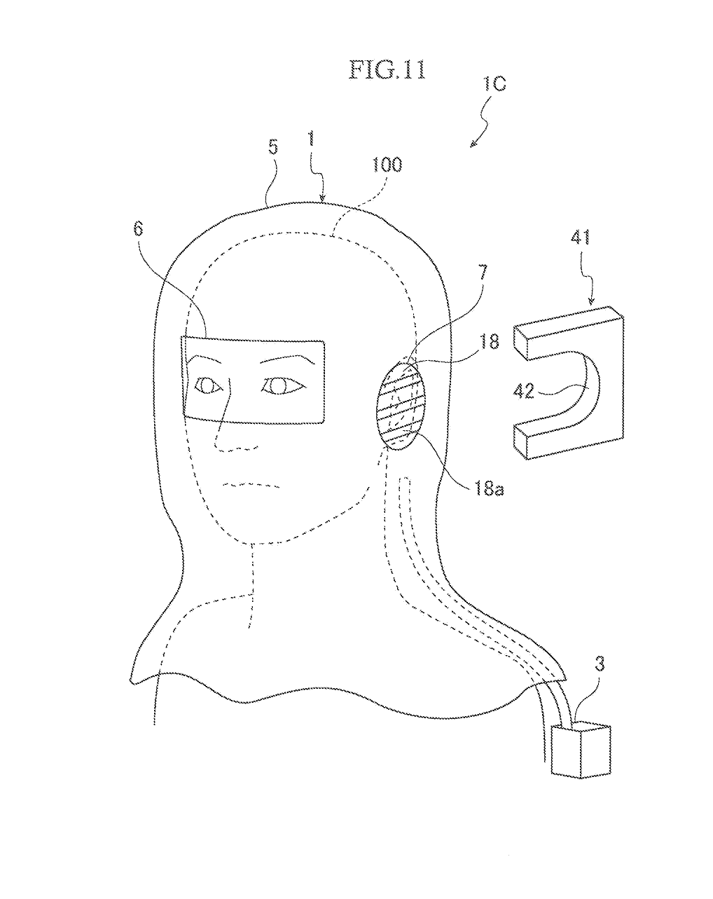

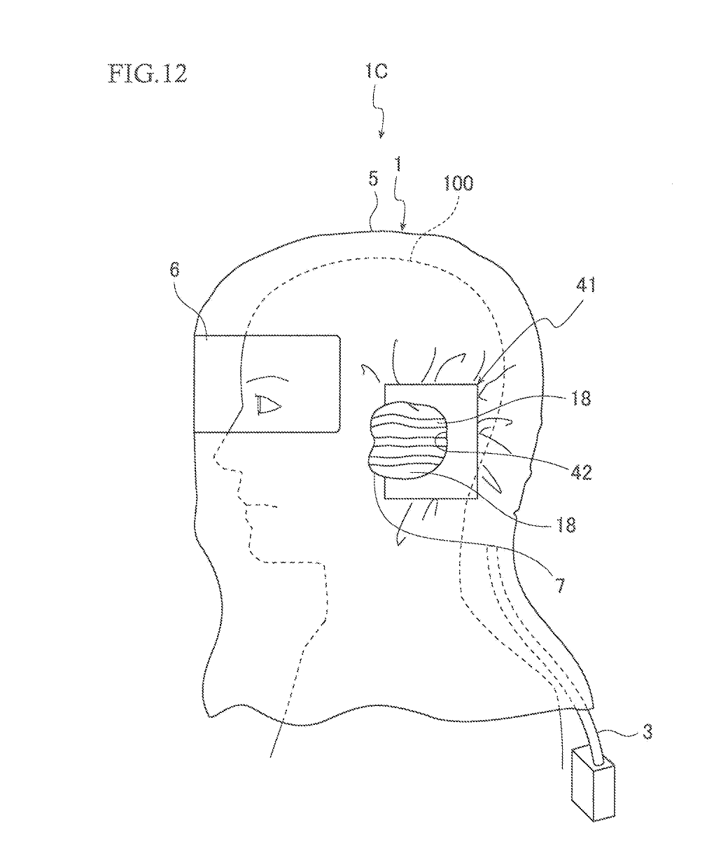

FIGS. 11 and 12 show a third embodiment of the present invention.

Instead of the ear film member unit 2 of the protective garment 1A in the first embodiment, a protective garment 1C in the third embodiment includes ear pressing members 41 shown in FIG. 11 as the “ear pressing member” and the “maintaining member”.

The ear pressing members 41 in the third embodiment shown in FIG. 11 are made of a highly rigid material, for example an acrylic resin. As shown in FIG. 11, each ear pressing member 41 includes a curved portion 42. The curved portion 42 is curved in a substantially U shape approximately following the shape of the back of the root of a human auricle. The curved portion 42 may be in any shape as long as at least part of it approximately follows the shape of the back of the root of the human ear 101. For example, the ear pressing member 41 may be formed in a ring shape, and its entire inner periphery may be formed in a substantially arc shape.

In the protective garment 1C in the third embodiment, the hood 1 has the ear film members 18 attached to the ear openings 7. Other components are the same as the first embodiment.

In the third embodiment, the wearer 100 wears the hood 1 of the protective garment 1C and then fits the ear pressing members 41 into positions corresponding to the back of the ears 101 over the hood 1 to attach the ear pressing members 41, as shown in FIG. 12. Accordingly, the curved portions 42 of the ear pressing members 41 are engaged in the positions corresponding to the roots of the auricles of the wearer 100 over the hood 1, and the ear film members 18 are disposed in contact with or in proximity to the ears of the wearer 100. Since attaching the ear pressing members 41 causes the portions of the hood 1 around the ear film members 18 to be pressed against the areas around of the ears 101 of the wearer 100, the ears 101 of the wearer 100 can be insulated from noises transmitted into the hood 1.

Thus, in the third embodiment, the wearer 100 wears the hood 1 and then engages the curved portions 42 of the ear pressing members 41 in the positions corresponding to the roots of the auricles of the wearer 100 over the hood 1. In this manner, the ear film members 18 can be easily kept in contact with or in proximity to the ears 101 of the wearer 100.

Although the protective garment 1C in the third embodiment does not include sound insulating members, the protective garment 1C may include sound insulating members. Although the wearer 100 in FIGS. 11 and 12 does not wear the protective mask 4 used in the first embodiment, the wearer 100 may wear the protective mask 4.

### Fourth Embodiment of Invention

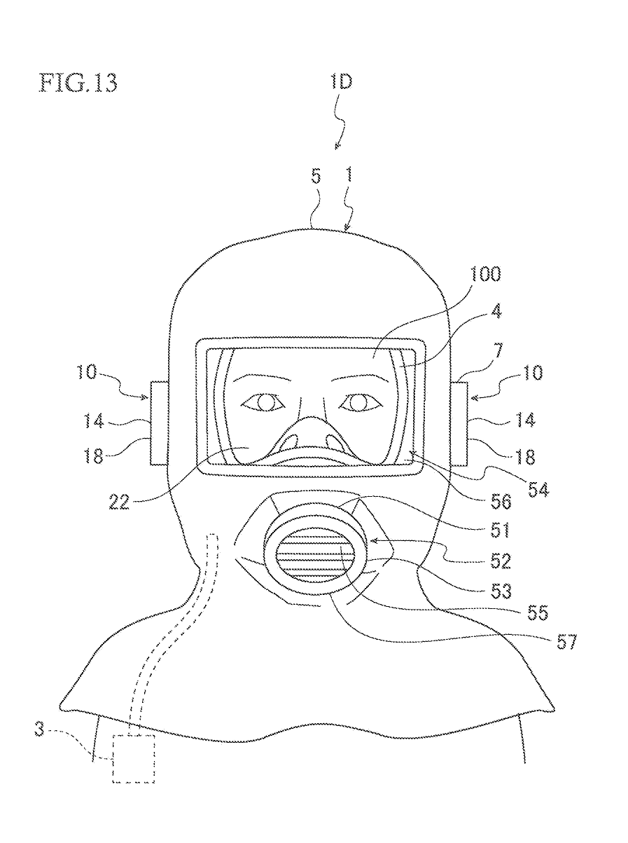

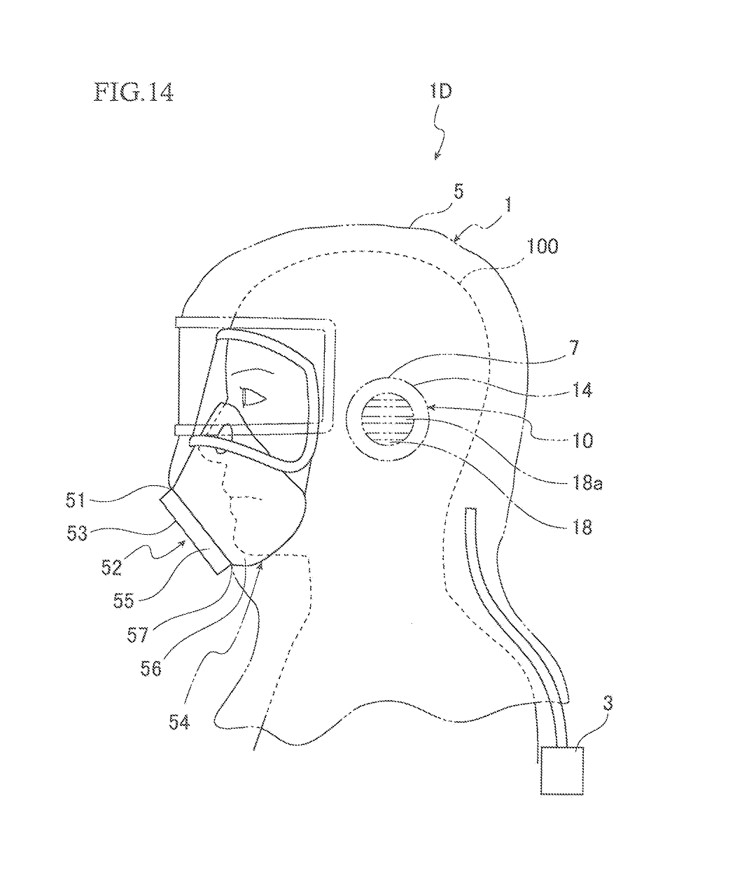

FIGS. 13 and 14 show a fourth embodiment of the present invention.

The fourth embodiment is different from the first embodiment in the following point. In addition to the components of the protective garment 1A in the first embodiment, a protective garment 1D in the fourth embodiment has a mouth opening section 51 formed in the hood 1, and a mouth film member unit 52 is provided in the mouth opening section 51.

The mouth film member unit 52 shown in FIG. 13 includes a mouth film member adapter 53, and a protective mask 54 as the “mouth pressing member”. The mouth film member adapter 53 has the same configuration as the ear film member adapter 10 (see FIGS. 7A and 7B). A mouth film member 55 is attached to the outside of the mouth film member adapter 53. The mouth film member 55 is formed with the same material and thickness and in the same shape as the ear film member 18. However, the mouth film member 55 may be formed with any material and thickness and in any shape as long as speech of the wearer 100 can be clearly transmitted outside the hood 1. Although the mouth film member adapter 53 in the fourth embodiment is detachable from the hood 1, the mouth film member adapter 53 may be integrated into the hood 1.

As shown in FIG. 14, in the fourth embodiment, the wearer 100 wears the protective mask 54 instead of the protective mask 4 in the first embodiment. The protective mask 54 is different from the protective mask 4 in the first embodiment in that an insertion opening 57 is formed in a mouth portion of a mask main body 56 so that the mouth film member adapter 53 can be attached to the insertion opening 57. Other components are the same as in the first embodiment.

In the fourth embodiment, when using the protective garment 1D, the wearer 100 attaches the mouth film member adapter 53 to the protective mask 54 and puts the protective mask 54 on his head, as shown in FIG. 14. The wearer 100 then wears the hood 1 and attaches the mouth film member adapter 53 to the mouth opening section 51. In this state, the protective mask 54 is pressed by rubber bands (not shown) against the head of the wearer 100 including the area around of his mouth, accordingly, the mouth film member 55 of the mouth film member adapter 53 is disposed at a position corresponding to the mouth of the wearer 100 because.

That is, in the fourth embodiment, during the use of the protective garment 1D, the mouth film member 55 of the mouth film member adapter 53 is disposed at the position corresponding to the mouth of the wearer 100 to allow speech of the wearer 100 to be even more clearly transmitted outside.

Although the rubber bands (not shown) of the protective mask 54 are used to press the “mouth pressing member” against the area around the mouth of the wearer 100 in the fourth embodiment, this is not limitation. For example, the protective mask 54 may be attached to the inner surface of the hood 1 so that the protective mask 54 is disposed at the position of the mouth of the wearer 100 under the weight of the protective mask 54 itself.

Although the wearer 100 wears the protective mask 54 in the fourth embodiment, this is not limitation. For example, instead of the protective mask 54, a voice transmission cup without an air-purifying function may be provided at the mouth.

In the foregoing embodiments, the “protective garment main body” is implemented as the hood 1. However, this is not limitation. The “protective garment main body” may be implemented in any form as long as it covers at least the head. For example, the “protective garment main body” may be a hood-type respiratory protector covering only the head of the wearer 100, a protective garment covering the head and upper body of the wearer 100, or a protective garment covering the head and entire body of the wearer 100.

In the foregoing embodiments, the protective garment 1A is provided with the air supplier 3 so that purified air is sent into the hood 1. Alternatively, the protective garment 1A may be provided with a breathing apparatus that supplies air or oxygen from a tank (such as an air cylinder) internal or external to the hood 1 into the mask main body 22 of the protective mask 4 through a tube. The protective garment 1A may also not be provided with the air supplier 3 or the breathing apparatus.

It is to be understood that the foregoing embodiments are merely illustration of the present invention and are not intended to limit the present invention only to the foregoing embodiments.

### FIRST EXAMPLE

Now, a first example of the present invention will be described.

In the first example, sound transmission performance was measured in a protective garment having a configuration similar to the protective garments 1A, 1B, 1C, and 1D according to the first to fourth embodiments. The measurement was performed for ring-shaped earmuffs each having an opening in a portion corresponding to an ear (hereinafter simply referred to as “earmuffs”) disposed at ears of an artificial head. As an inventive case, an ear film member (a fluorine resin film of 45 mm in diameter made of a 0.025-mm-thick material) was applied to each earmuff. As a case for comparison, the same material as the body-covering section of the hood (a 0.4-mm-thick material of a soft vinyl chloride) was applied to each earmuff as in a conventional technique.

In the inventive case of the first example, pink noise was generated from a speaker about 2 meters away from the artificial head and adjusted so that set sounds in the earmuffs with the openings were about 70, 80, and 90 dB, and changes in sound pressure in the earmuffs were examined. The same measurement was also performed for the case for comparison. Background noise in the earmuffs was 27.4 dB for both cases.

In the inventive case and the case for comparison, a difference within 6 dB in sound pressure from a set sound was regarded as a good result (i.e., the wearer 100 can hear external sounds well), and a difference above 6 dB was regarded as a bad result.

Results are shown in <Table 1>.

TABLE 1

| Background noise | 27.4 | | |
|---|---|---|---|
| Set sound | 70.4 | 80.4 | 90.5 |
| Inventive case | 66.8 | 77.2 | 87.6 |
| Case for comparison | 59.4 | 69.4 | 79.5 |

As shown in <Table 1>, in the inventive case, differences in sound pressure from all the set sounds were within 6 dB, indicating good results. In contrast, in the case for comparison, differences in sound pressure from all the set sounds were above 6 dB, indicating bad results. Thus, it was verified that, unlike in the case for comparison, the wearer in the protective garment in the inventive case was able to clearly hear external sounds.

### SECOND EXAMPLE

Now, a second example of the present invention will be described.

In the second example, measurement was performed in a protective garment with ear film members disposed at ear openings to see differences in hearing with respect to differences in distance between the ear film members and ears.

In the second example, a test subject wore a hood with the ear film members disposed at the ear openings (but without components corresponding to the “sound insulating members” in the first and other embodiments). Pink noise was generated from a speaker about 2 meters away from the test subject and adjusted so that a set sound in the hood was about 75 dB. Changes in sound pressure in earmuffs were examined for both cases in which an air supplier in the hood was not in operation and was in operation. Background noise in the earmuffs was 75 dB when the air supplier 3 was in operation, and 50 dB when not in operation.

In the second example, measurement based on subjective evaluation was performed as to whether the test subject was able to hear the sound from the speaker for distances of 0, 3, 5, 7, and 9 mm between the edges of the ears of the test subject and the ear film members.

Results are shown in <Table 2>.

TABLE 2

| Distance (millimeter) | 0 | 3 | 5 | 7 | 9 |
|---|---|---|---|---|---|
| With air supply | ◯ | ◯ | ◯ | Δ | X |
| Without air supply | ◯ | ◯ | ◯ | ◯ | ◯ |

◯: well heard
Δ: moderately heard
X: poorly heard

As shown in <Table 2>, when the air supplier was in operation, good results were obtained for the distances within 5 mm between the edges of the ears and the ear film members, whereas bad results were obtained for the distances equal to or more than 7 mm. When the air supplier was not in operation, good results were obtained irrespective of the distance between the edges of the ear and the ear film members.

Thus, it was verified that, if the distance between the edges of the wearer's ears and the ear film members was within 5 mm, the wearer was able to hear external sounds well irrespective of whether the air supplier is in operation or not.

### THIRD EXAMPLE

Now, a third example of the present invention will be described.

In the third example, as an inventive case, a protective garment with ear film members disposed at ear openings formed in portions corresponding to the wearer's ears (but without components corresponding to the “sound insulating members” in the first and other embodiments) was put on an artificial head. Changes in sound pressure were measured for a case in which an air supplier in the hood was in operation and a case in which a respiratory protector with an electric fan was in operation and producing noises. As a case for comparison, a protective garment similar to the one presented herein in “Background Art” (i.e., a protective garment without ear film members and without sound insulating members around portions corresponding to the ears) was put on an artificial head, and the same measurement was performed.

Results are shown in <Table 3>.

TABLE 3

Respiratory protector with

| Air supplier | | electric fan | |
|---|---|---|---|
| Inventive case | Case for | Inventive | Case for |
| (dB) | comparison (dB) | case (dB) | comparison (dB) |
| 64.4 | 75.4 | 65.7 | 76.8 |

As shown in <Table 3>, the inventive cases can reduce sound pressure of the noises by more than 10 dB compared to the case for comparison. Thus, it was verified that the configuration of the inventive case was able to reduce noises at the ear portions.

### FOURTH EXAMPLE

Now, a fourth example of the present invention will be described.

In the fourth example, as an inventive case, test subjects wore the protective garment used in the inventive case described in [Third Example], and measurement was performed for listening of spoken sounds played outside the protective garment. Specifically, a sound level meter was placed near each test subject's ears, and a sound source for correction was played to adjust the speech sound pressure to approach a certain level (75 dB in this example). The air supplier was operated in the protective garment so that noises were transmitted into the hood. Each test subject in the protective garment then listened to 50 two-syllable words played from a speaker, and the number of correct answers was counted. As a case for comparison, the test subjects wore the protective garment used in the case for comparison described in [Third Embodiment], and the same measurement was performed under the same conditions. Four test subjects underwent the measurement in the inventive case and the case for comparison.

Results are shown in <Table 4>.

TABLE 4

| | Inventive case | Case for comparison |
|---|---|---|
| | (the number of | (the number of |
| | correct answers/the | correct answers/the |
| Test subject | number of test items) | number of test items) |
| Test subject 1 | 46/50 | 18/50 |
| Test subject 2 | 44/50 | 11/50 |
| Test subject 3 | 28/50 | 11/50 |
| Test subject 4 | 42/50 | 24/50 |

As shown in <Table 4>, it was verified that external spoken sounds were able to be clearly heard in the protective garment in the inventive case.

### REFERENCE SIGNS LIST

1A, 1B, 1C, 1D protective garment
1 hood (protective garment main body)
2, 31 ear film member unit (maintaining member)
3 air supplier
4 protective mask
9 ear pressing member
11, 33 sound insulating member
18 ear film member
23 rubber band (ear pressing member)
32 plate member
41 ear pressing member (ear pressing member, maintaining member)
42 curved portion
54 protective mask (mouth pressing member)
55 mouth film member
100 wearer
101 ear

1. A protective garment comprising:
a protective garment main body covering at least a head of a wearer;
an ear film member formed with a thickness allowing hearing of external sounds; and
a maintaining member maintaining the ear film member in contact with a wearer's ear or in proximity to the wearer's ear within a predetermined distance,
wherein the maintaining member comprises a sound insulating member disposed to surround the wearer's ears to reduce sounds reaching the wearer's ears without passing through the ear film members.

2. The protective garment according to claim 1, wherein
the maintaining member maintains the ear film members in contact with or in proximity to the wearer's ear by applying force to the ear film members or to portions where the ear maintaining member are located in the protective garment main body, in a direction toward the wearer's ears.

3. (canceled)

4. The protective garment according to claim 1, wherein
the maintaining member further comprises an ear pressing member made of an elastic material,
openings are provided at both ends of the ear pressing member, respectively,
the sound insulating members are provided on the inner surface of the ear pressing member to surround the respective openings,
the ear film members are attached to the respective openings, and
the sound insulating members are pressed against areas around the wearer's ears due to elastic force of the ear pressing member.

5. The protective garment according to claim 4, wherein
the ear pressing member is worn to surround the wearer's ears and back of the head.

6. The protective garment according to claim 4, wherein
the maintaining member further comprises a vertex band section, one end of the vertex band section being connected to one of the ends of the ear pressing member, and another end of the vertex band section being connected to the other end of the ear pressing member.

7. The protective garment according to claim 6, wherein
the vertex band section comprises an attaching member to detachably attach the vertex band section to the inner surface of a vertex portion of the protective garment main body.

8. The protective garment according to claim 1, wherein
the maintaining member further comprises a pair of substantially flat plate members,
openings are provided in the respective plate members,
the sound insulating members are provided on the inner surface of the plate members to surround the respective openings,
the ear film members are attached to the openings, and
the plate members are pressed by an ear pressing member against areas around the wearer's ears.

9. The protective garment according to claim 8, wherein
the ear pressing member is a fastening band to fix a protective mask to the wearer's head.

10. The protective garment according to claim 1, wherein
an ear film member is provided in the protective garment main body, and
the maintaining member contains an ear pressing member having a curved portion formed to be curved, the curved portion being engaged in a position corresponding to a root of each auricle of the wearer over the protective garment main body.

11. The protective garment according to claim 1, wherein
the ear film member is detachably provided in the protective garment main body.

12. The protective garment according to claim 4, wherein
the ear pressing member is detachably provided in the protective garment main body.

13. The protective garment according to claim 1, wherein
an air supplier sending air into the protective garment main body, or a breathing apparatus supplying air in a tank to the wearer through a tube, is provided in the protective garment.

14. The protective garment according to claim 1, wherein
a mouth opening is formed in a portion of the protective garment main body corresponding to the wearer's mouth, and
a mouth film member transmitting the wearer's speech to the outside is provided at the mouth opening.

15. The protective garment according to claim 14, wherein
the ear film members are made of the same material as the mouth film member.

16. The protective garment according to claim 14, further comprising
a mouth pressing member provided outside the mouth film member, the mouth pressing member being pressed against an area around the wearer's mouth so that the mouth film member is disposed in a portion corresponding to the wearer's mouth.

17. The protective garment according to claim 10, wherein
the ear pressing member is detachably provided in the protective garment main body.
